(19) United States
(12) Patent Application Publication
(10) Pub. No.: US 2003/0179568 A1
(43) Pub. Date: Sep. 25, 2003

(54) Lighting system

(76) Inventor: Bruno Lanbach, Mils (AT)

Correspondence Address: WENDEROTH, LIND & PONACK, L.L.P., 2033 K STREET N. W., SUITE 800, WASHINGTON, DC, 20006-1021, US

(21) Appl. No.: 10/391,553

(22) Filed: Mar. 20, 2003

(30) Foreign Application Priority Data
Mar. 22, 2002 (AT) A 444/2002

(51) Int. Cl. F21V 21/08

(52) U.S. Cl. 362/104; 362/391

(57) ABSTRACT

A lighting system having at least one decorative transparent member which has at least one bore, having at least one light source for illuminating the, at least one, decorative transparent member, and having a mechanical holder which extends into the bore for holding or hanging the, at least one decorative transparent member, wherein the light source(s) is (are) arranged in the bore(s) of the decorative transparent member(s), and the current supply to the light source(s) takes place through the respective holder.

The present invention relates to a lighting system having at least one decorative transparent member which has at least one bore, having at least one light source for illuminating the, at least one, decorative transparent member, and having a mechanical holder which extends into the bore for holding or hanging the, at least one, decorative transparent member.

Lighting systems with a decorative transparent member, e.g. in the form of an ornament, have long since been known. Their aesthetic appeal is increased by locating a light source either on or in the decorative transparent member because of the multiple reflections of, and interruptions to, the light emerging from the decorative transparent member.

There are many different embodiments of decorative lighting system. U.S. Pat. No. 5,656,530 discloses a lighting system, for example, where the light source is located in an opaque holder which is connected by a wire to the decorative transparent member. U.S. 5,876,109 describes a lighting system with a decorative transparent member in the form of an ornament in which a light source is arranged in a blind bore which is made specifically for the purpose. The holder is outside the bore.

The aim of the invention is to create a lighting system which is of simple construction and visually appealing.

This is obtained according to the invention in that the light source(s) is (are) arranged in the bore(s) of the decorative transparent member(s), and the current supply takes place to the light source(s) through the respective holder.

This invention is advantageous economically and technically because it is possible for the light source to be introduced into the bore of the decorative transparent member which was already needed hitherto for the mechanical holder. This avoids any modifications to existing devices which would be costly economically and technically. Particularly advantageously, a customary lustre ornament with a bore can be used without modification. The bore carries out the dual role of receiving the holder (as hitherto) and the light source. This is now advantageous in that the light source does not require any separate holder. Rather, good light is introduced into the decorative transparent member by way of the light source which is disposed inside the bore.

One advantageous embodiment of the invention provides that a light diode (LED) is selected as the light source. This combines compact design with high light intensity and a low current requirement.

Another advantageous embodiment of the invention results if a light diode is accommodated in recessed manner in a recess provided for it in the part of the mechanical holder disposed in the bore. This allows the light source to be located in a decorative transparent member which was not originally designed for that purpose.

Another advantageous embodiment of the invention results if the decorative transparent member of the lighting system has a plurality of blind bores into each of which a light diode can be placed. This permits the uniform internal illumination of larger decorative transparent members.

Another advantageous embodiment of the invention results if the mechanical holder of the lighting system is designed in the region of the decorative transparent member as two straps held under spring tension and permitting frictional fixture of the light sources which are placed loosely in the respective bore. This embodiment is particularly user-friendly because of the possibility to change over defective light sources quickly.

Another advantageous embodiment of the invention results if the mechanical holder consists largely of glass fibre-reinforced plastic material, preferably epoxy resin. A mechanical holder is produced thereby which has advantageous mechanical properties and low inherent weight.

Another advantageous embodiment of the invention results if the mechanical holder, in the region of the decorative transparent member, is in the form of an elongate strap. This permits a plurality of light sources to be accommodated in the same bore.

Another advantageous embodiment of the invention results if two oppositely disposed sides of the mechanical holder are coated over the entire length thereof at least partially with an electrically conductive layer. The presence of conductive layers permits cable-free current supply from light sources which are contacted by the mechanical holder. This is advantageous in aesthetic terms.

Another advantageous embodiment of the invention results if the mechanical holder is in the form of a hook-type suspension means in the region of the free end which is remote from the bore, and if the hook-type suspension means has electrically conductive contact faces, each of which is connected to a conductive layer. As a result, the lighting system can be detachably suspended from any form of conductor rail, wherein the gravitational force acts as a contact pressure, and costly screwing or clamping of the lighting system to the conductor rail becomes redundant. The avoidance of connecting the lighting system to an external current source, which is costly in technical terms, results in low susceptibility to interference. A particularly advantageous aspect of this embodiment is the ability to arrange a plurality of lighting systems in freely selectable locations on one and the same conductor rail.

Further features and details of the present invention will emerge from the following description of the accompanying drawings, wherein:

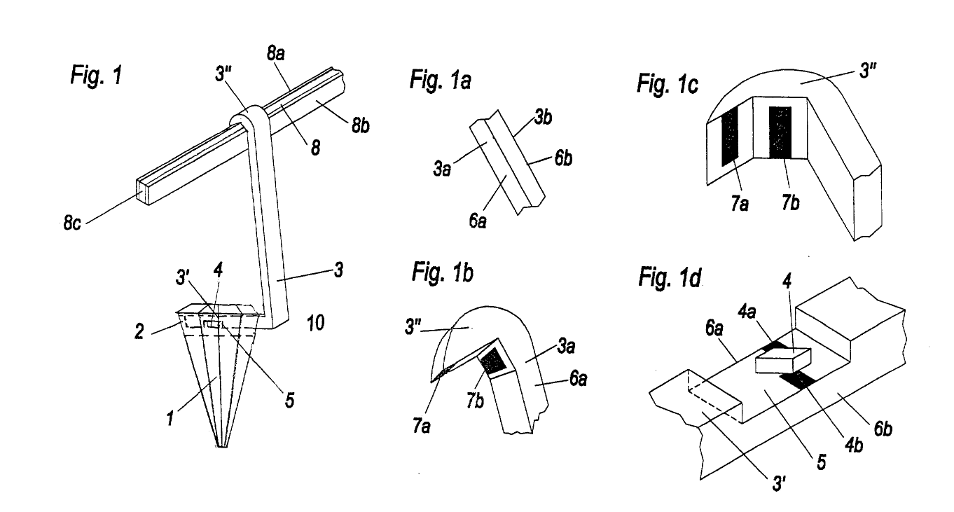

FIGS. 1 and 1a to 1d show a lighting system according to the invention, and also various detailed views of same,

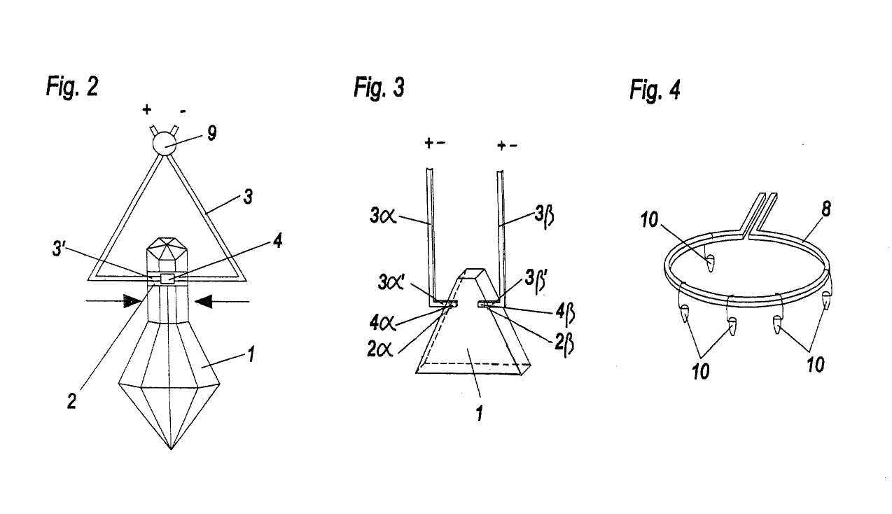

FIG. 2 shows another embodiment of the invention,

FIG. 3 shows another embodiment of the invention,

FIG. 4 shows an example of an application in which a plurality of lighting systems according to the invention is used.

FIG. 1 shows a lighting system 10 with a decorative transparent member 1 in the form of a lustre ornament which is provided with a substantially horizontally extending (through)bore 2 by means of which it is suspended detachably to a rigid mechanical holder 3. A light diode 4 is secured in recessed manner, in a recess 5, to the part 3′ of the mechanical holder 3 disposed in the continuous cylindrical bore 2. The supply of current is by way of the conductive layers 6a, 6b (see FIG. 1a) which are disposed on the lateral faces 3a, 3b of the mechanical holder 3 and which extend over the entire length of the holder 3, and which open into contact faces 7a, 7b which are mutually oppositely disposed to each other at an angle, at the side, remote from the conductor rail, of the top region 3″ of the holder 3 which is in the form of a suspension means (see FIGS. 1b and 1c). The electrical connection to an external current source happens by way of the contact pressure of the suspension means 3″, produced by gravitational force, upon a contact rail 8 of a bar-like design, which has different electric potentials on mutually oppositely disposed lateral faces 8a, 8b arranged on either side of an insulating layer 8c. FIG. 1d shows a detailed view of the recess 5, where contacting of the various poles 4a, 4b of the light source 4 which is in the form of a light diode in this embodiment can be seen.

FIG. 2 shows another embodiment of the invention. Here, it is provided that the light diode 4 is accommodated loosely in the through bore 2 of the decorative transparent member 1, and is electrically contacted on both sides of the bore 2 by the mechanical holder 3 which is designed in the region of the decorative transparent member 1 as a clamp 9 held under spring tension. As a result, the electric circuit across the light diode 4 is closed.

FIG. 3 shows another embodiment of a lighting system 10 according to the invention, wherein two light diodes 4∀, 4∃ are disposed in mutually oppositely disposed blind bores 2∀, 2∃, and the current supply to the light diodes 4∀, 4∃ is effected by way of the respective mechanical holder 3∀, 3∃.

FIG. 4 shows an example of an application where a plurality of lighting systems 10 according to the invention are suspended detachably from an annular conductor rail 8.

Clearly, the invention is not limited to the embodiments shown. Rather, it can be provided, in particular, that a light bulb, possibly coloured, is used as the light source, that the decorative transparent member is designed as an ornament, that the decorative transparent member has both through bores as well as blind bores, that a plurality of decorative transparent members is arranged on a mechanical holder, or that the decorative transparent member has a colour which is inherent to itself.

1. A lighting system having at least one decorative transparent member which has at least one bore, having at least one light source for illuminating the at least one decorative transparent member, and having a mechanical holder which extends into the bore for holding or hanging the at least one decorative transparent member, characterised in that at least one light source is arranged in said at least one bore of the decorative transparent member, and the current supply to said at least one light source takes place through the respective holder.

2. A lighting system according to claim 1, characterised in that at least one light source is a light diode (LED).

3. A lighting system according to claim 1, characterised in that said at least one light source is fixed to the respective holder.

4. A lighting system according to claim 1, characterised in that said at least one light source is inserted loosely into said bore, and the respective current-carrying holder makes electrical contact with said light source or its mounting.

5. A lighting system according to claim 1, characterised in that at least one bore is designed as a through bore.

6. A lighting system according to claim 1, characterised in that at least one bore is designed as a blind bore.

7. A lighting system according to claim 6, characterised in that two blind bores are in approximately oppositely disposed relationship.

8. A lighting system according to claim 1, characterised in that said at least one bore has a diameter of less than 5 mm.

9. A lighting system according to claim 1, characterised in that the decorative transparent member is a facetted glass body.

10. A lighting system according to claim 1, characterised in that the decorative transparent member is a lustre decoration.

11. A lighting system according to claim 1, characterised in that the decorative transparent member is an ornament.

12. A lighting system according to claim 1, characterised in that said at least one bore of the decorative, transparent member when mounted extends in a substantially horizontal direction.

13. A lighting system according to claim 1, characterised in that said at least one bore of the decorative transparent member is cylindrical and of constant diameter.

14. A lighting system according to claim 1, characterised in that the holder can be inserted removably into said bore.

15. A mechanical holder for a decorative transparent member of a lighting system, characterised in that it is of a rigid configuration.

16. A mechanical holder according to claim 15, characterised in that the mechanical holder is made of reinforced plastic material.

17. A mechanical holder according to claim 15, characterised in that the part of the mechanical holder which extends into the bore of the decorative transparent member is in the form of an elongate strap.

18. A mechanical holder according to claim 17, characterised in that the strap has at least one opening in which at least one light source is respectively arranged.

19. A mechanical holder according to claim 15, characterised in that two oppositely disposed sides of the mechanical holder are coated over the entire length thereof at least partially with an electrically conductive layer.

20. A mechanical holder according to claim 19, characterised in that an electrically conductive layer is connected to one pole of the light source and the other electrically conductive layer is connected to the other pole of the light source.

21. A mechanical holder according to claim 15, characterised in that the mechanical holder is in the form of a hook-type suspension means in the region of the free end which is remote from the bore.

22. A mechanical holder according to claim 15, characterised in that the hook-type suspension means has electrically conductive contact faces which can be detachably connected to a conductor rail.

23. A mechanical holder according to claim 22, characterised in that one of the contact faces is connected to the electrically conductive layer on the one side of the mechanical holder, and another contact face is connected to the electrically conductive layer on the oppositely disposed side of the mechanical holder.

24. A mechanical holder according to claim 23, characterised in that the hook-type suspension means can be mounted to a conductor rail consisting of faces held at different electrical potentials arranged on either side of an insulating layer such that the gravitational force acts like a contact pressure, and one contact face is pressed against the one face of the conductor rail which is placed at one potential, and another contact face is pressed against the other face of the conductor rail which is placed at the other potential.
